(19) United States
(12) Patent Application Publication
(10) Pub. No.: US 2025/0107651 A1
(43) Pub. Date: Apr. 3, 2025

(54) Musical Tea Kettle with Improved Safety Features

(71) Applicant: Christian Gibbs Kendall, Sonora, CA (US)

(72) Inventor: Christian Gibbs Kendall, Sonora, CA (US)

(21) Appl. No.: 18/375,263

(22) Filed: Sep. 29, 2023

(51) Int. Cl. A47J 27/212; A47J 27/21

(52) U.S. Cl. CPC A47J 27/212; A47J 27/21191

(57) ABSTRACT

The present invention provides an improved safety tea kettle apparatus with multiple components that enhance safety. The present invention to provide a kettle with an improved steam diverting mechanisms that offers the user increased protection from steam and hot liquids by deflecting them. Another feature of the new improved kettle includes sealing means comprised within the kettle opening ushering dangerous away from the pouring mechanism. Material considerations also provide a safer handling to prevent burns while grasping the kettle for pouring. Additionally, the disclosed kettle comprises improved whistling mechanisms that provide musicality along with enhanced safety measures.

### CROSS-REFERENCE TO RELATED APPLICATIONS

The present non-provisional utility application claims the benefit of Provisional Patent Application No. 63/411,449 filed Sep. 29, 2022.

### FIELD OF THE INVENTION

The present invention relates generally to household vessels for boiling liquids and having steam driven musical apparatus. More particularly, the present invention relates to enhanced safety features for a musical tea kettle apparatus for boiling liquids, providing an audible notification to a user when a liquid has reached a boiling point.

### BACKGROUND OF THE INVENTION

It is well known in the art that kettles provide a convenient container for heating water. In particular, kettles used on a kitchen stove are typically referred to as “teakettles” in view of their primary function, that is preparing the hot water for tea. Tea kettles are formed from a metal container body capable of holding water, the container capable of withstanding repeated heating from a stove top. The container body is substantially closed with a pour spout that includes a top. Typically, the top of the pour spout includes an orifice to allow air expansion during the heating process. In addition, the orifice provides the familiar “whistle” found on tea kettles. Pressure relieved through the orifice results in a low-pressure steam whistle which provides an audible signal indicating that the water has reached the boiling point.

Modifications to the conventional teakettle include variations on the whistle. For instance, U.S. Pat. No. 4,813,368 discloses a steam driven musical tea kettle that requires a pressure range for proper operation. Other prior art such as Hutter's Musical Tea Kettle U.S. Pat. No. 4,813,368 sought to provide a distinctive audible indication when the liquid was heated to boiling point. U.S. Pat. No. 6,540,120 to Lebowitz for a Kettle with improved Opening Mechanism focuses on the handle apparatus for modulated control of the opening and closing of the kettle spout. Additionally, previous prior art such as U.S. Pat. No. 3,130,881 to Jepson, U.S. Pat. No. 5,490,616 to Stowell et al. and U.S. Pat. No. 6,006,959 to Naden et al each illustrate various kettles with varying means of spout handles and pouring mechanisms, but all fall deficient of providing enhanced safety from the steam and/or boiling liquid.

### SUMMARY OF THE INVENTION

As is well known in the art, traditional tea kettles are widely used for use in heating water or the like to be used, for example, in making tea or other beverages, etc. Such tea kettles include a kettle body for receiving a supply of water, wherein the kettle body is constructed from a material which will permit direct exposure to a source of heat.

In many popular tea kettle configurations, the kettle body is maintained substantially closed while water therein is heated to a boiling condition to generate steam. The generated steam in turn operates a low-pressure steam whistle to provide an audible signal indicating that the water has reached the boiling condition. In some modern tea kettle configurations, this audible notification to a user is provided by a whistling body mechanism activated by the flow of steam. However, this flow of steam can prove to be dangerous and can scald users as they operate the kettle and/or pour boiling liquids from said kettle.

The present invention provides a novel tea kettle construction designed to provide a distinctive audible indication when water therein is heated to boiling. There exists a significant market for safe, attractive tea kettles having unique aesthetic or functional characteristics in addition to general utility for boiling fluids. In particular, the present invention provides a compact steam-powered musical unit for operating a group of steam whistles in such a manner producing a selected musical tune.

Accordingly, it is an object of the present invention to provide a kettle with an improved handle mechanism that offers the user increased protection from steam and hot liquids.

It is a further object of the present invention to provide a kettle with an improved opening mechanism that deflects harmful steam away from the user.

It is still a further object of the invention to provide a kettle with an improved opening mechanism that provides an enhanced seal for deflecting steam away from the user.

It is yet a further object of the invention to provide enhanced materials for the handle of the kettle to prevent burns while grasping the kettle for pouring.

It is still a further object of the invention to provide a kettle with an improved whistling mechanisms that provides musicality along with enhanced safety measures.

In the description herein, numerous specific details are provided, such as examples of components and/or methods, to provide an understanding of embodiments of the present invention. One skilled in the relevant art will recognize, however, that an embodiment of the invention can be practiced without one or more of the specific details, or with other apparatus, systems, assemblies, methods, components, materials, parts, and/or the like.

### BRIEF DESCRIPTION OF THE DRAWINGS

The accompanying drawings illustrate the invention. In such drawings:

FIG. 1 is a perspective view illustrating a musical tea kettle embodying the novel features of the invention;

FIG. 2 is a fragmented vertical sectional view taken generally on the line 2-2 of FIG. 1;

FIG. 3A is a side view diagram of the kettle unit illustrating geometric detail;

FIG. 3B is a top view diagram of the kettle unit;

FIG. 4A is a perspective diagram of the winged handle assembly;

FIG. 4B is a side view diagram of the winged handle assembly of FIG. 4A;

FIG. 4C is a vertical cross sectional side view diagram of the winged handle assembly of FIG. 4A;

FIG. 5A is an enlarged exploded perspective view illustrating assembly of components forming the musical tea kettle;

FIG. 5B is an exploded perspective view illustrating assembly details of components forming the musical tea kettle including the handle mechanism and musical components;

FIG. 6A is a perspective diagram illustrating pitch pipe array;

FIG. 6B is a side view diagram of the pitch pipe array of FIG. 6A;

FIG. 7A is a side view diagram of the gasket element; and

FIG. 7B is a vertical cross sectional side view of the gasket of FIG. 7A.

The novel features which are characteristic of the invention, as to organization and method of use, together with further objects and advantages thereof, will be better understood from the following disclosure considered in connection with the accompanying drawings in which one or more preferred embodiments of the invention are illustrated by way of example. It is to be expressly understood, however, that the drawings are for the purpose of illustration and description only and are not intended as a definition of the limits of the invention.

As used herein, the term “comprises” refers to a part or parts of a whole but does not exclude other parts. That is, the term “comprises” is open language that requires the presence of the recited element or structure or its equivalent but does not exclude the presence of other elements or structures. The term “comprises” has the same meaning and is interchangeable with the terms “includes” and “has”. The term set has the meaning of one or more of said element. Furthermore, any use of the term “or” as used herein is generally intended to mean “and/or” unless otherwise indicated. Combinations of components or steps will also be considered as being noted, where terminology is foreseen as rendering the ability to separate or combine is unclear.

### DETAILED DESCRIPTION

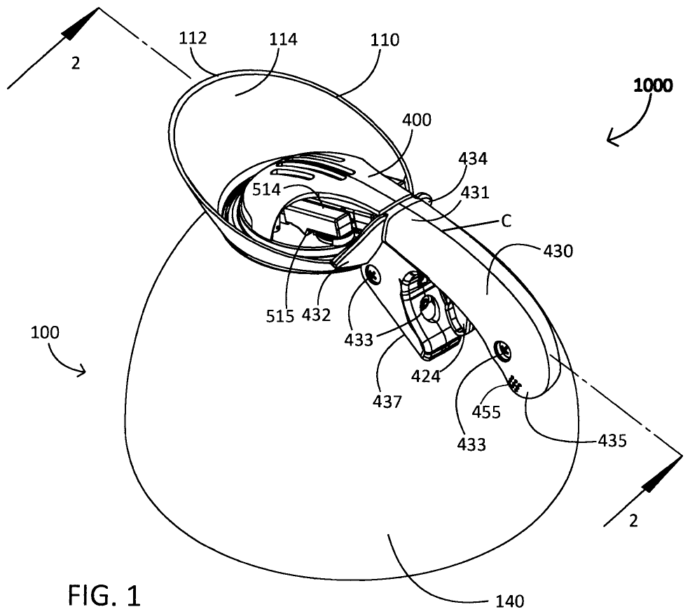

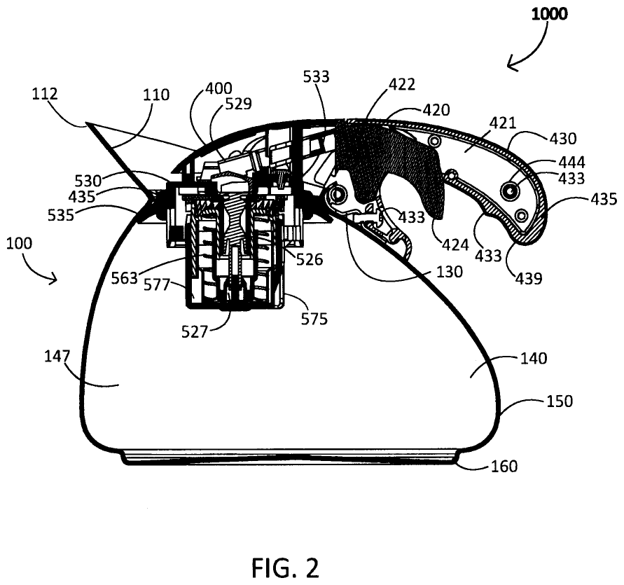

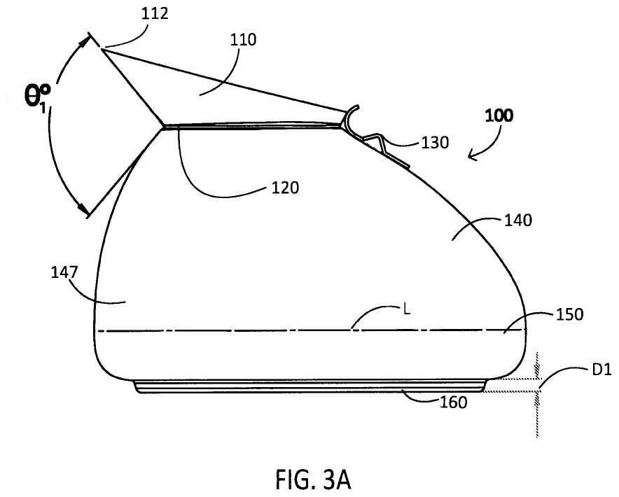

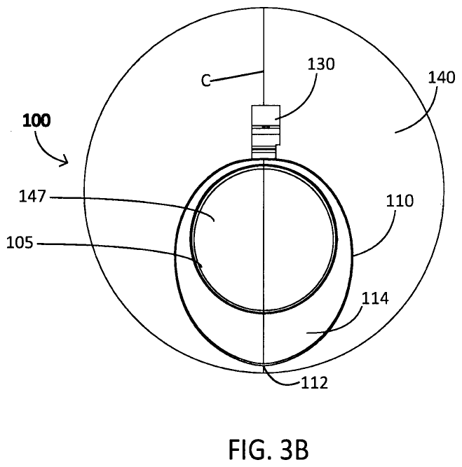

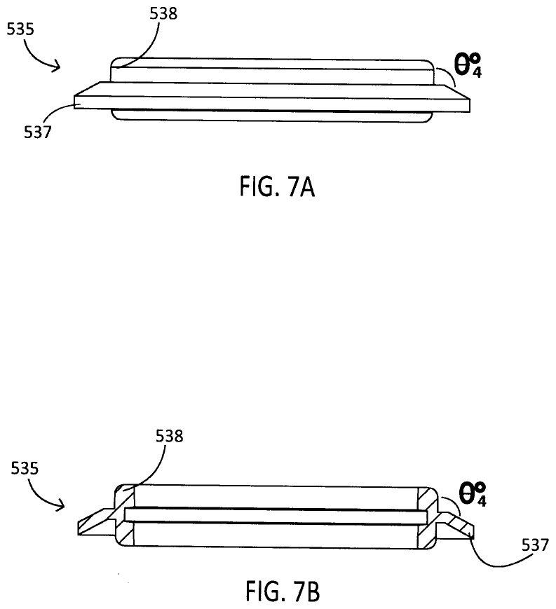

A preferred embodiment of a novel singing tea kettle with improved safety features shown in the exemplary drawing FIGS. 1-7B. As can be gleaned in FIG. 1, a musical tea kettle (MTK) 1000 is shown in FIG. 1 which includes the kettle unit 100, a steam powered music box assembly (MBA) 500 and pivoting, shielding heat assembly (PSHA) 400. FIGS. 2-7B illustrate the components and features of the musical tea kettle in further detail. FIG. 2 is a fragmented vertical sectional view taken generally on the line 2-2 of FIG. 1 and provides further details of the elements of the components described in detail below. FIGS. 3A and 3B show the kettle unit 100 in further detail. FIG. 3A is a side view diagram of the body of the kettle unit 100 illustrating geometric detail, and FIG. 3B is a top view diagram of the kettle unit 100.

The kettle unit 100 is a unitary structure formed of several major components welded together. In the preferred embodiment, the unitary structure is metal and formed of melded stainless steel components comprised of a beveled contoured spout (BCS) 110, metal coupling ring (MCR) 120, handle bracket 130, and parabolic kettle body (PKB) 140 having an offset parabolic shape, a geometric base 150 on a geometrically matching anchoring baseplate (GMAB) 160. In preferred embodiments, the kettle unit 100 is constructed from an appropriate material, such as steel, copper or other suitable metals capable of withstanding exposure to a suitable heat source for heating and boiling liquids within the MTK 1000, all in a well-known manner.

The kettle unit 100 comprises a PKB 140 having an offset mouth/opening forming an upper orifice 105 with BCS 110 into which water can be placed into or poured out from the MTK 1000. The BCS 110 is welded and coupled to the kettle body 140 by MCR 120. MCR 120 is likewise comprised of stainless steel and serves as connection juncture between the orifice 105 of the BCS 110 and the kettle body 140. The BCS 110 has a curved surface forming the curved lip 114 extending radially by approximately 1.5 inches from the orifice 105 to the tip 112 at an angle Θ₁ for funneling liquids. In preferred embodiments the angle Θ₁ is approximately within the range of 90-110 degrees, with 100 degrees being a preferred angle. The orifice 105 is offset from the center of the kettle body 140 to facilitate safe pouring of heated liquids emminating steam.

A handle bracket 130 is spot welded to the upper portion of the kettle body for coupling to the PSHA 400. In a preferred manufacturing process that includes laser welding of the steel components as well as spot welding of the components using only stainless-steel electrodes when thermally melding the metal components together to form a smooth, stainless-steel structurally unitary kettle body 100—thus averting future oxidation resulting from any dissimilar metals (at melded points) when exposed to steam, water or other liquids being heated.

In one embodiment, the GMAB 160 takes on the geometric form of a circle is concentrically coupled to said circular base. The geometrically matching, concentric relationship of the geometric base 150 and GMAB 160 provide structural support preventing tipping of the MTK 1000 providing stabilization and counterbalance to the offset parabolic dimensions of the PKB 140, (as can be gleaned from FIG. 3A) thus facilitating enhanced safety when handling boiling hot liquids. Without departing from the scope of the invention, other examples of matching geometric relationships between the geometric base 150 and GMAB 160 could include rounded triangular base and a triangular anchoring baseplate, or rectilinear and a rectangular anchoring baseplate, as corresponding examples.

The phantom line L demarks the welding line between the PKB 140 and GMAB 160 indicating the beginning of the circular and relative concentric diameters of the geometric base 150 until it tapers at its juncture with GMAB 160. The GMAB 160 has a height D1, which in a preferred embodiment has a range of approximately 0.2-0.25 inches thick forming a solid, weighted base. This height D1 not only serves to stabilize the MTK 1000 but additionally, the clearance serves as thermal heat sink.

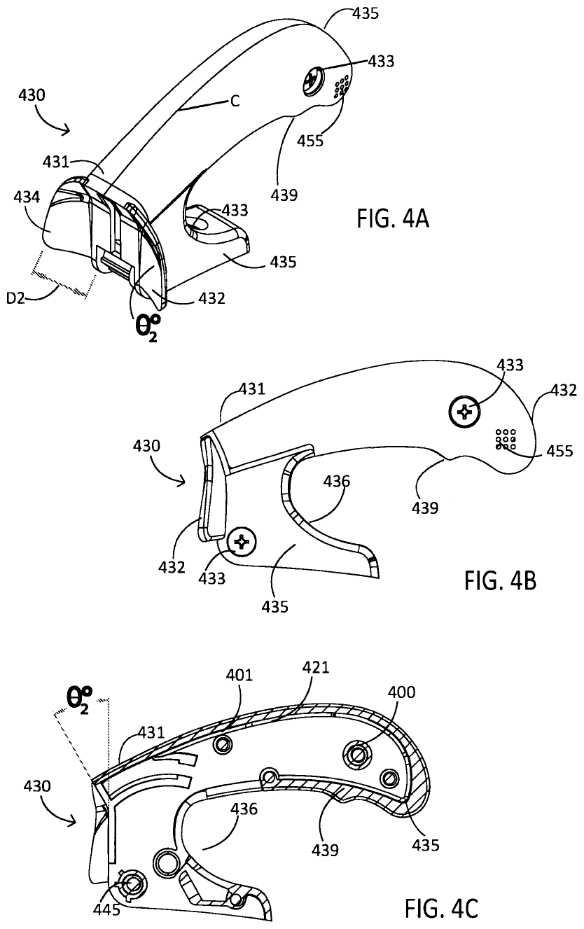

FIGS. 4A-C are diagrams of the winged handle assembly (WHA) 430 that extends radially as the handle mechanism of the PSHA 400. The PSHA 400 includes a base 437 shaped to seat substantially flush against the exterior of the PKB 140 in a position generally adjacent the orifice 105. Mounting screws 433 matingly couple to tapped inner recesses 445 for securing the handle components. In a preferred embodiment, the WHA 430 may be comprised of an inner metal core body 421 of stainless steel encased in an outer rubberized layer 435 made of a low durometer polymer providing enhanced friction for handling as well as providing a thermal buffer layer for the handle's metal core body 420. The size, dimension and contour of the base 435 is formed with egresses and curves 436 facilitating enhanced ergonomic form fitting for the hand of a user.

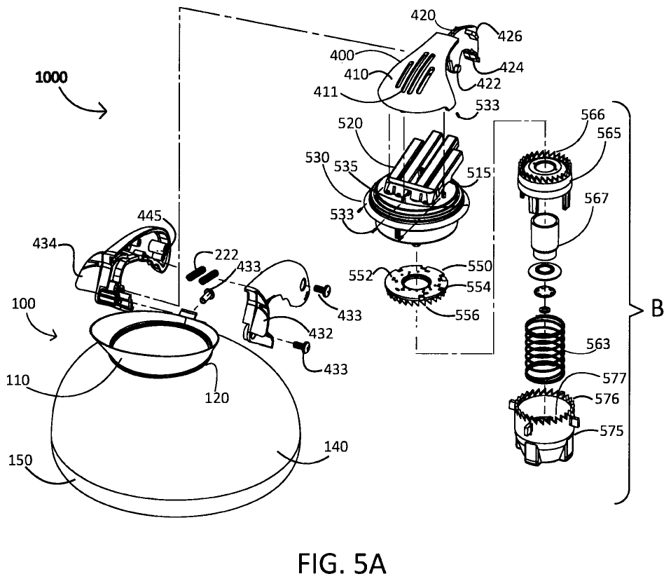

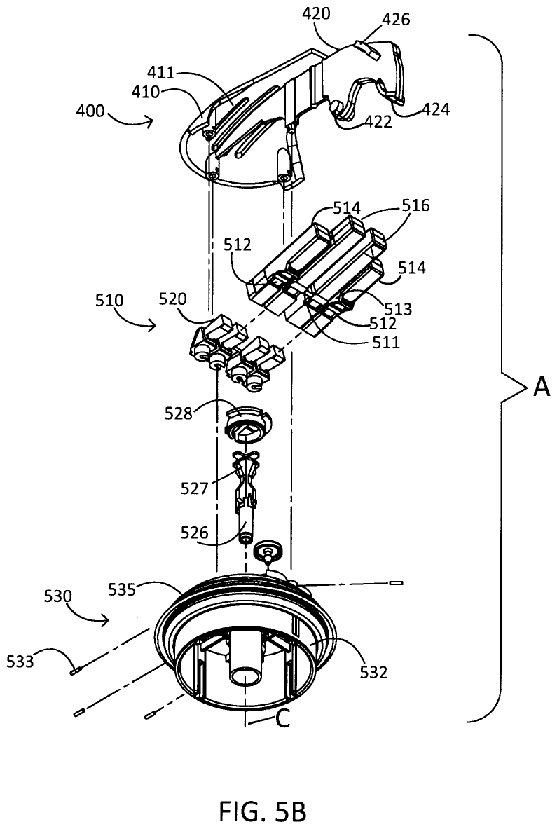

The PSHA 400 has a downwardly sloping, curved heat shield 410 containing steam vents 411 and is pivotably mounted via a set of spring-loaded pivoting rods 422 (with springs 222, FIG. 5A). Gripping protrusions 439 at the distal handle end 439 along with an array of griping notches 455 provide structure for facilitate friction enhanced actuation of the PSHA 400. The proximal end of the WHA 430 has a set of concave wings 432, 434 that extend perpendicularly a distance (D2) relative to the central axis C. The radially extending curved set of concave wings 432, 434 each extend radially outward and away from the proximal end 431 of the WHA 430 by a minimum of approximately 1 inch and having a curved surface at an angle Θ₂ that is approximately 30 degrees relative to the vertical axis in a preferred embodiment—and can range between 25-35 degrees. This structure and dimension of the wings 432, 434 serves to diverts the steam away from the hand of the user thus enhancing protections from burns and scalding when handling boiling liquids.

The MBA 500 is shown in the exploded perspective diagrams of FIGS. 5A and 5B, and generally comprises the pitch pipe array (PPA) 520 mounted on the box housing 532 with a sloping sealing gasket (SSG) 535 circumferentially encasing the music box housing 532. The MBA 500 is a compact subassembly designed to be mounted generally within the kettle's orifice 105 (note also FIG. 2). In one embodiment, as shown in the exemplary drawings, the MBA 500 can be integrated into the PSHA 400, designed for convenient handling of the MTK 1000 and manipulation of the MBA 500 to an out-of-the-way position during water ingress or egress with respect to the kettle interior chamber 147. Sets of stainless-steel pins 533 position and anchor the MBA 500 to the kettle unit 100.

The cross-sectional view of FIG. 2 detail diagrams of 7A and 7B illustrate yet another critical safety feature of the instant invention. The sloping sealing gasket (SSG) 535 extends peripherally around MBA 500 and has a beveled downward sloping lip 537 ramping up toward the orifice 105 which slopes downward within the PSHA 400 (in both open and closed configurations, note FIG. 2) and serves to provide an airtight seal as well as a deflection means for deflecting dangerously hot liquids. This SSG 535 is comprised of a suitable rubberized material for facilitating airtight sealing and has a downward sloping beveled lip 537 that extends radially from the ring body 538 at an angle Θ₄ of approximately 73 degrees.

In the exploded views of FIGS. 5A and 5B, the MBA 500 is shown having a PPA 510 comprised of a set of pitch pipes 514, 516 (connected by pipe rod 511) providing the music once the kettle's liquid reaches boiling point. The PPA 510 provide passage of the steam between the interior passages thereof, and thus produces the tunes as the steam enters. The steam is guided up through the MBA 500 from the interior chambers 567, 577 of the steam driven piston assembly (STPA) indicated by bracket B. Spring 563 translates axially as steam moves up through the STPA causing piston housing 565, 575 to rotate as teeth 566, 556, 576 engage.

Steam flowing between these surfaces is exhausted into the elongated interiors of each pitch pipe 514, 516 having a set of one or more beveled apertures forming steam discharge ports (SDP) 512 to produce an audible note having a pitch in accordance with the overall size and shape, particularly length, of the pitch pipe 514,516 (i.e., different dimension producing different pitches). In a preferred embodiment the pitch pipes 514, 516 are pitched to notes C, D, E and F. While four pitch pipes 514, 516 are shown in the illustrative drawings to play a four-note tune, such as “Tea for Two,” any number of such pitch pipes may be provided, as desired depending on the song. Steam generated by boiling water within the kettle chamber 147 is supplied to the SSG 535 in a controlled and timed manner by a rotatable song disc 550, as can be gleaned in FIG. 5A. The rotation in a predetermined and pretimed fashion into alignment with the pitch array 510 allows steam to discharge upwardly into the PPA 510 in a manner playing the selected tune. Further, song disc 550 (which contain a series of protrusions notches 552, 554) rotates due to the pressure of the steam emanating from the chambers and produces the song (as programmed by the location of the notches 552, 554) can be interchanged with discs having different songs ‘notched out’ on the surface.

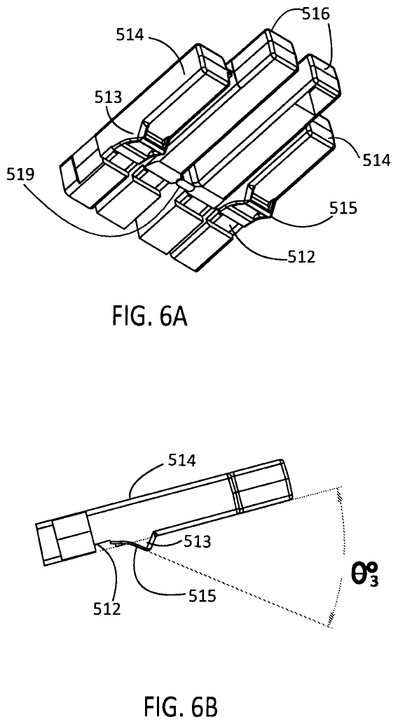

As with yet another enhanced safety feature of the invention, FIGS. 6A and 6B illustrate a set of diverting pitch pipes (DPP) 514 comprised of diverters 515 formed by ramped portions 513, adjacent the SDP 512, which serve as structural deflection means for diverting the dangerously hot steam away from the PSHA 400 and thus the user's hand during the pouring of a hot liquid from the MTK 1000. In a preferred embodiment, the diverters 515 ramp away from the horizontal plane and surface thereof at an angle Θ₃ in the range of 35-39 degrees, as can be gleaned in FIG. 6B.

The foregoing description of illustrated embodiments of the present invention, including what is described in the Abstract, is not intended to be exhaustive or to limit the invention to the precise forms disclosed herein. In some of the Figures, various dimensions are presented to provide a scope of the sizing of the kettle and its components and should not be construed as definitive and limiting but rather descriptive of a preferred embodiment of the invention. In some embodiments, other configurations can be realized with the simple addition and/or subtraction of particular parts.

While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

I claim:

1. A musical tea kettle assembly, having
a unitary kettle body comprised of melded components including:
a kettle housing having
a conically shaped pour spout,
said pour spout extending from a coupling ring joining said spout to said kettle body,
said kettle housing having an irregular geometric shape
whose proximal portion forms an opening and distal portion forms a symmetric geometric base, and
a stabilizing baseplate;
said kettle housing having a handle bracket coupled to said kettle housing and
a handle assembly pivotably attached to said handle bracket,
said handle assembly comprising a proximal shield portion and a distal handle portion,
and said distal handle portion has a set of concave wings;
a music box assembly for producing music,
said music box assembly comprises a housing, a pitch pipe array mounted to said housing,
a song disc coupled to said pitch pipe array, and
and a steam driven piston mechanism for actuating said song disc and pitch pipe array; and
a steam diverting gasket having a circular body extending peripherally about said music box assembly housing.

2. A musical tea kettle assembly of claim 1, wherein
said unitary kettle body is formed of stainless steel;
and wherein said geometric shape of the kettle body is parabolic with
a circular geometric base and stabilizing baseplate.

3. A musical tea kettle assembly of claim 2, wherein
said concave wings radially extend perpendicularly relative to a central axis of said handle;
and wherein the distal handle portion has a rubberized coating about its periphery,
and said distal handle portion comprise gripping means.

4. A musical tea kettle assembly of claim 3, wherein
said concave wings radially extends perpendicularly by a distance of at least one inch.

5. A musical tea kettle assembly of claim 4, wherein
said concave wings have a curved angle of approximately 30 degrees.

6. A musical tea kettle assembly of claim 5, wherein
said conical pour spout has a beveled lip; and
wherein said gripping means comprises notches and protrusions on said rubberized coating.

7. A musical tea kettle assembly of claim 3, wherein
said pitch pipe array includes a set of whistle pipes, each sized and dimensioned to play a musical note.

8. A musical tea kettle assembly, having
a unitary kettle body comprised of
a kettle housing having
a pour spout,
said pour spout extending from a coupling ring joining said spout to said kettle body,
said kettle housing having an irregular geometric shape whose proximal portion forms an opening and distal portion forms a symmetric geometric base, and
a stabilizing baseplate;
said kettle housing having a handle bracket coupled to said kettle housing and
a handle assembly pivotably attached to said handle bracket,
said handle assembly comprising a proximal shield portion and a distal handle portion having a pivot,
and said distal handle portion has a set of concave wings;
a music box assembly for producing music,
said music box assembly comprises a housing, a pitch pipe array mounted to said housing,
a song disc coupled to said pitch pipe array, and
and a steam driven piston mechanism for actuating said song disc and pitch pipe array; and
a steam diverting gasket having a circular body extending peripherally about said music box assembly housing; and
wherein said pitch pipe array includes a set of pipes having ramped diverters formed thereon adjacent said steam discharge ports.

9. The musical kettle assembly of claim 8,
wherein said diverters are of a ramped portion extending from the horizontal plane.

10. The musical kettle assembly of claim 9,
wherein said steam diverting gasket has a circular body extending peripherally about said music box assembly housing;
and further comprises a lip extending radially from said circular body at a downward sloping angle.

11. The musical kettle assembly of claim 10,
wherein said downward sloping angle is approximately 73 degrees, and wherein said lip has a beveled ledge.

12. The musical kettle assembly of claim 11, wherein said song discs are interchangeable.

13. A singing tea kettle assembly for boiling liquids comprising
a unitary kettle body having
a rounded parabolic kettle housing, with a conical pour spout, and a stabilizing baseplate;
a handle assembly pivotably attached to said kettle housing;
a music box assembly comprising a housing, a fluid diverting sealing gasket having a circular body extending peripherally about said music box assembly housing; and
a whistle pitch pipe array mounted to said housing for producing musical notes,
and a steam driven piston mechanism for driving steam through said array;
and wherein said tea kettle assembly comprises compounding steam diverting safety mechanisms for diverting boiling fluids away from a hand of a user;
and wherein a first steam diverting mechanism comprises a handle assembly having a concave wing extending radially from said handle assembly, and
wherein a second steam diverting mechanism includes said fluid diverting sealing gasket having a downward sloping beveled lip;
wherein a third steam diverting mechanism comprises a set of ramped whistle pitch pipes.

14. The singing tea kettle assembly of claim 13 wherein
said concave wings extend radially from said handle assembly perpendicularly by a distance of at least one inch and have a curved angle of approximately 30 degrees.

15. The singing tea kettle assembly of claim 14 wherein
said concave wings radially extends perpendicularly by a distance of at least one inch.

16. The singing tea kettle assembly for boiling liquids of claim 15 wherein said set of ramped whistle pitch pipes includes pipes with a ramped portion having an angle of approximately 37 degrees.
